(19) United States
(12) Patent Application Publication
(10) Pub. No.: US 2017/0119200 A1
(43) Pub. Date: May 4, 2017

(54) Automated beverage and fragrance synthesizers

(71) Applicant: Anthony David Bressi, Danville, PA (US)

(72) Inventor: Anthony David Bressi, Danville, PA (US)

(21) Appl. No.: 15/407,326

(22) Filed: Jan. 17, 2017

Related U.S. Application Data
(60) Provisional application No. 62/280,154, filed on Jan. 19, 2016.

(51) Int. Cl. A47J 31/40

(52) U.S. Cl. CPC A47J 31/407

(57) ABSTRACT

Disclosed are devices which enable the on-demand in situ synthesis of a wide range of beverages or fragrances. The requested product is created component by component under the guidance of a component profile, for that product, which resides in a computerized database. The component by component synthesis of the product is made practical through a collection of component cartridges. These cartridges are similar to those found in ink jet and other printers. Other procedures, such as carbonation, stirring, frothing, heating, and so on, can be performed on the beverage as required by other mechanisms which may be incorporated into the device.

### CROSS-REFERENCE TO RELATED APPLICATIONS

This application claims the priority benefit under 35 USC 119(e) from Provisional Application No. US 62/280,154, “Automated Beverage and Fragrance Synthesizers,” filed on the 19^{th} day of Jan. 2016 and which is incorporated herein in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### FIELD OF THE INVENTION

The present invention relates to beverage and fragrance (e.g., perfume and/or cologne) creation and dispensing systems.

### BACKGROUND OF THE INVENTION

Traditional beverage dispensers can be divided into two broad categories, those that dispense a pre-mixed beverage and those that prepare the beverage in situ. Either category of dispenser offers a rather limited selection of beverages which may be dispensed. Pre-mixed dispensers, the typical example of which are soda or juice vending machines, rarely offer more than a dozen choices of beverages from which the consumer may chose. In situ mixing dispensers, such as coffee and tea vending machines and soda fountains, offer similarly limited solutions.

The various efforts to offer the consumer more options or customized options in beverage selection has generated considerable prior art.

U.S. Pat. No. 6,514,933 issued to T. J. Young and M. J. Incorvin describes a process for creating a flavor or fragrance formulation in which a laser is used to monitor the titration of a flavor or fragrance. It is not focused on machines for direct consumer use.

U.S. Pat. No. 6,759,072 issued to R. W. Gutwein and C. W. Connor discloses a system for making and delivering a customized beverage based upon brewing an extract and then utilizing delayed dilution, mixing, or filtering.

U.S. Pat. No. 6,845,704 issued to Z. G. Lassota and M. W. Lassota discloses a beverage brewing system using flow meter measurement and control.

U.S. Pat. No. 7,048,217 issued to T. D. Dickson, Jr. et al describes a blending station and method for blending various foodstuffs and other ingredients for incorporation into beverages.

U.S. Pat. No. 7,077,290 issued to T. W. Bethuy et al describes a system of forming and dispensing a beverage that utilizes the controlled dilution of a concentrate.

U.S. Pat. No. 7,156,259 issued to T. W. Bethuy et al describes a system of forming and dispensing a beverage that is largely similar to, and appears as an extension of, U.S. Pat. No. 7,077,290.

U.S. Pat. No. 7,438,941 issued to R. W. Gutwein and C. W. Connor discloses a system for making and delivering on demand a customized beverage based upon brewing an extract and then utilizing delayed dilution, mixing, or filtration that is largely similar to, and appears to be an extension of, U.S. Pat. No. 6,759,072.

U.S. Pat. No. 7,611,031 issued to H. C. Crisp, III and T. E. Duff discloses a beverage dispensing apparatus utilizing a valve actuator control system to dispense and dilute drinks from multiple supply canisters.

U.S. Pat. No. 7,806,294 issued to S. B. Gatipon et al discloses systems and methods for dispensing flavor doses and blended beverages incorporating multiple supply lines carrying water and beverage additives.

U.S. Pat. No. 7,899,713 issued to L. M. Rothschild provides a system and method for creating a personalized consumer product based on identifying a user and matching the user with the user's product preferences as stored on a computer server.

U.S. Pat. No. 8,003,145 issued to R. W. Gutwein and C. W. Connor discloses a system and method for making and delivering a customized brewed beverage product using an user interface and stored consumer preference data and is largely an extension of U.S. Pat. Nos. 6,759,072 and 7,438,941.

U.S. Pat. No. 8,161,865 issued to G. T. Tso et al describes a modular flavor dispenser that pumps several flavors to a separate food or beverage machine.

U.S. Pat. No. 8,306,655 issued to D. R. Newman discloses systems and methods for providing portion control programming in a product forming dispenser.

U.S. Pat. No. 8,417,377 issued to L. M. Rothschild provides a system and method for creating a personalized consumer product. It is largely based upon U.S. Pat. No. 7,899,713.

U.S. patent application Ser. Number 12/842,405 by W. Metropulos et al provides for an automatic beverage dispenser which mixes liquors with mixer syrups.

U.S. patent application No. 13/021,607 by D. E. Tilton et al describes a custom beverage vending system using a plurality of ingredient reservoirs interconnected with a mixing manifold.

U.S. patent application Ser. No. 12/940,265 by D. A. Bippert describes a method of beverage production, apparatus, and system which mixes two components based upon a beverage attribute profile.

U.S. patent application Ser. No. 13/165,452 by W. Metropulos and T. Knecht discloses a system and method for dispensing a beverage and is largely based upon U.S. Pat. No. 12/842,405.

None of these provide a practical means to create a plurality of basic beverages that number in the hundreds, thousands, or more. Furthermore, none provides a practical means of reliably duplicating the taste, smell, color, viscosity, and texture of any of the beverages within their repertoire. Instead they rely on the consistency of beverage components that are mostly mixtures of multiple compounds, usually in the form of extracts or concentrates.

Modern analytical techniques in chemistry, namely gas chromatography (“GC”), high performance liquid chromatography (“HPLC”), inductively-coupled plasma-atomic absorption spectroscopy (ICP-AAS), viscometry, colorimetry, and electronic pH metering allow for the very thorough characterization of the properties and composition of various materials including beverages and fragrances. Color ink jet printers create a full range of colors by combining very small dots of different colored inks. These inks are dispensed in picoliter to nanoliter quantities from special dispensing cartridges which integrate the ink reservoir with a piezoelectric, or other micromechanical, dispensing system. The small quantities dispensed correlate well with the smallest quantities of the components of beverage and fragrances which contribute to taste, odor, color, acidity, viscosity, and other properties detectable to humans. This provides the potential to duplicate practically any beverage or fragrance if the proper compounds are available.

Ink jet printer technology allows for the precision dispensing of very small quantities of fluid. Ink jet printer cartridges are modular fluid reservoirs that may be designed for easy refill of the contents. They are also easy, and economical, to manufacture.

### BRIEF SUMMARY OF THE INVENTION

The present invention advantageously utilizes technology developed for ink jet printers coupled with detailed knowledge of the chemical composition, color, acidity, viscosity, serving temperature (for beverages), and other properties of various beverages or fragrances, attained, at least in part, through the use of analytical techniques, to manufacture any of said beverages or fragrances, on demand, utilizing basic chemical constituents.

A beverage or fragrance (perfume, cologne, or similar composition) is first analyzed to determine its chemical composition. High-performance liquid chromatography (HPLC), gas chromatography, infrared spectroscopy, mass spectroscopy, inductively-coupled plasma-atomic absorption spectroscopy (ICP-AAS), and other analytical techniques may be utilized to create the “component profile” of said beverage or fragrance. This component profile is stored in a computerized database. Other analytic techniques are performed to determine the other properties, such as color, viscosity, texture, and pH, of said beverage or fragrance. This information along with serving information, such as serving temperature, if applicable and desired, are stored in a database for later retrieval.

To recreate the beverage or fragrance, a consumer selects the beverage or fragrance from the available menu of beverages or fragrances and selects the quantity desired. The synthesizer then accesses the beverage's or fragrance's “component profile” and other data stored in the database or selected by the consumer. The synthesizer utilizes this information to determine which components and how much needs to be dispensed along with what processing techniques, such as mixing or carbonation, must be applied in order to reproduce the beverage or fragrance. In some embodiments, differently sized cartridges may dispense major, minor, and trace components to create the product. Additionally, in some embodiments, various means may be provided to aerate, carbonate, inject steam into, agitate, stir, homogenize, heat, chill, or otherwise alter, modify, or manipulate the product.

Furthermore, some embodiments may incorporate means to analyze various properties of the components and/or product. Such properties may include color, pH, and viscosity. Some embodiments may incorporate means to adjust said properties in order to bring them within a predetermined acceptable range as provided within the database's information on the product.

### BRIEF DESCRIPTION OF THE SEVERAL VIEWS OF THE DRAWING

The foregoing aspects and others will be readily appreciated by the skilled artisan from the following description of illustrative embodiments when read in conjunction with the accompanying drawings.

FIG. 1 illustrates a schematic of the general layout of the components of an Automated Beverage Synthesizer capable of producing a wide range of beverages.

FIG. 2 shows a view of a portion of the bottom of an array of component cartridges, for an Automated Beverage Synthesizer, held in their carrier.

FIG. 3 shows a view of a portion of the top of an array of component cartridges, for an Automated Beverage Synthesizer, held in their carrier.

FIG. 4 illustrates a component cartridge for an Automated Beverage Synthesizer.

### DETAILED DESCRIPTION OF THE INVENTION

Before the invention is described in detail, it is to be understood that, unless otherwise indicated, this invention is not limited to particular embodiments, materials, and processes, as such may vary. It is also to be understood that the terminology used herein is for the purposes of describing particular embodiments only, and is not intended to be limiting.

As used in the specification and the appended claims, the singular forms “a,”“an,” and “the” include plural referents unless the context clearly indicates otherwise.

In this specification and the appended claims, reference will be made to a number of terms that shall be defined to have the following meanings:

The terms “optional” or “optionally” mean that the subsequently described feature or structure may or may not be present, or that the subsequently described event or circumstances may or may not occur, and that the description includes instances where a particular feature or structure is present and instances where it is not, or instances where the event or circumstance occurs and instances where it does not.

The terms “cartridge” and “component cartridge” means a removable container incorporating means of dispensing discrete quantities of fluid or powder coupled with reservoir containing, or capable of containing, said fluid or powder which may be comprised of a single chemical component, or a composition with a known ratio of components, which may be a major, minor, or trace component of a composition which may be produced by the device, unless context indicates otherwise.

The term “product” means, depending upon context, the beverage or fragrance either made or to be made by the device, unless context indicates otherwise.

The term “requester” means, depending on context, the person or device requesting a particular product be made in a specified quantity, unless context indicates otherwise.

The term “component” means a singular chemical entity, either a chemical compound or element, which is a constituent of the product, unless context indicates otherwise.

The term “component profile” means, depending upon context, either the list of single chemical components and their associated occurrences, usually expressed as a percentage of the total, for a given product; this list with the addition of other physical parameters for the product; or the actual physical manifestations of said lists.

The term “fluid” means, unless context indicates otherwise, a liquid under normal environmental conditions (i.e., above 0° C. and below 60° C.).

Before embarking on descriptions of particular embodiments of the present invention, it would be beneficial to review the design principles of the disclosure.

Every beverage or fragrance is composed of a distinct set of chemical components. Sometimes the chemical composition alone is not sufficient to characterize the product. Examples would be the difference between a beer poured with no foamy head and a beer poured with one or a coffee served hot or one served cold. Chemically the beer or coffee is the same, but the drinker's sensory experience will be different due to the presence or absence of the foam or by the temperature of the beverage. In these instances, the beverage's component profile should include such physical parameters, and appropriately characterize them, in addition to the chemical composition of the beverage.

Modern analytical techniques allow for the rapid and accurate evaluation of both the physical and chemical characteristics of a beverage or fragrance. The present invention relies upon analytical techniques, such as high-performance liquid chromatography (“HPLC”); gas chromatography (“GC”); mass spectroscopy (“MS”); inductively-coupled plasma-atomic absorption spectroscopy (“ICP-AAS”); and visible, ultraviolet, and infrared spectroscopy, to determine the chemical and physical characteristics and components of a large number of products. Thus a component profile database is constructed. This database provides the information the synthesizer needs to reproduce or create the product.

Since it may be necessary to have available thousands of chemical components in order to provide the ability to synthesize a range of products, it is convenient to have these components in relatively compact, and refillable, cartridges. It would be advantageous if these cartridges also incorporated a means of delivering a range of discrete quantities of their contents. Some of these components may only be required in amounts of nanoliters (or micrograms) or less.

The cartridge technology developed originally for ink jet, and certain other, printers is a mature technology that is easily adapted to use in the present invention. These cartridges incorporate various systems capable of ejecting picoliter to nanoliter quantities of fluid in discrete bursts. The ejection is often accomplished with a piezoelectric system. Many of these same systems are suitable for use with the present invention. However, whereas an ink jet printer cartridge usually only contains an ejector or ejectors that ejects a single, uniform quantity of fluid, it would be advantageous for the component cartridges to incorporate several ejectors, or sets of ejectors, each capable of ejecting a different quantity of fluid. This would hasten product production as one product may require picoliter quantities of a component, while another product may require milliliter quantities of said component.

A means of combining all components of a particular product and delivering it to the appropriately sized container must also be provided. The often miniscule quantities of minor and trace components of a product prohibit the use of a manifold of some type or delivery lines for these purposes. The preferred embodiments of the present invention utilize ejection of the component directly into the fluid container. This container is moved relative to the various cartridges whose components are required to synthesize the product. Mixing can be accomplished in the fluid container itself through a variety of means.

Sometimes a component is not a liquid under normal conditions. If it is a solid that is soluble in one or more solvents, such as ethanol, or some other liquid solvent, then the cartridge, or cartridges as the case may be, may contain a solution of the component. However, the solvent may not be a component, or may be a lesser component, of the product. In such circumstances, it is advantageous to have a means incorporated into the device which may remove all or some of the solvent. For example, heating a solvent which is more volatile than the component, may remove the solvent via evaporation.

If the component is a gas under normal conditions, it is convenient to store it in cylinders which are connected to a mass or volume metering delivery system. Said delivery system may branch off to offer several options for the placement of said gas into the product. For example, carbon dioxide may be delivered to several carbonator components each capable of producing different size bubbles. Air, steam, carbon dioxide, and/or nitrous oxide are among the gases that may be injected directly into the product or a portion of the product using various designs of aerators or bubblers.

Physical attributes of the product, such as temperature, may be controlled through heating or chilling, accompanied with feedback from appropriate sensors, to match the requirements of the product's component profile or the requirements of the requester. Other physical manipulations, such as stirring or blending, may be accomplished in some embodiments with mixers or other appropriate implements which may be incorporated. It is recommended that a means of self-cleaning between product preparations be incorporated to minimize cross-contamination resulting from any residue from preparation of the previous product.

Product volume may be fixed to a given quantity within an appropriate tolerance range, it may be fixed to several pre-defined quantities, or it may be of some requested discrete quantity within a defined range. It is also convenient in many instances and embodiments to allow the requester to chose among variations in the composition of, or the physical attributes of, a particular product or products. For example, coffee with or without cream and/or sugar, the quantity, and the serving temperature. Also, optionally, the requester may be allowed to create new entries in the component profile database and/or define preferences; thus empowering the requester with the ability to create customized products or entirely new products which may be tied directly to them through a user name and/or creator name field in said database, which may or may not be accessible through a local or wide area network, such as the Internet. This may be facilitated through the employment of a user-friendly, wizard-style graphical user interface.

Now turning to the preferred embodiments of the present invention.

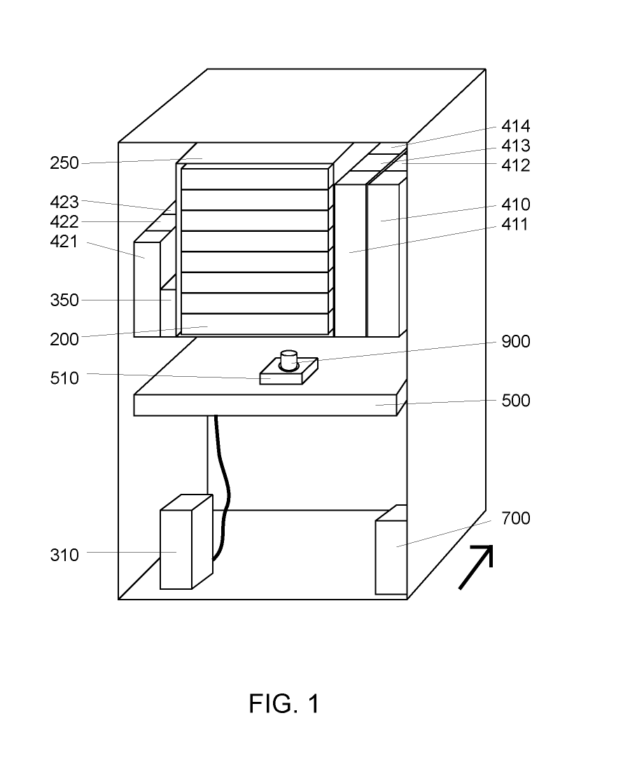

An example of an Automated Beverage Synthesizer (“ABS”) is illustrated in FIG. 1 sans the front covering with the user interface and in a simplified diagrammatic fashion to facilitate an understanding of the operation of an ABS. To utilize the device, the requester would utilize the ABS's user interface, or other device which can interface with the ABS, to convey the request for a particular beverage, perhaps chosen from the existing entries in the component profile database, modified from an existing component profile entry, or is a new entry created by the user, to computer/controller 700. The requester may specify other parameter, such as quantity, serving temperature, and/or frothing, and these are also passed to computer/controller 700. Note that it is advantageous for said user interface to incorporate drill-down menus for beverage choices/options.

An appropriately sized beverage container 900 is then placed into drink shuttle 510. The preferred embodiment of the drink shuttle 510 can hold beverage containers of differing diameters through the use of an adjustable diameter, irising gripping system.

Meanwhile, computer/controller 700, based upon the request made by the requester, looks up the requested beverage and other request information in the component profile database, calculates the component quantities and implements required, checks this against the ABS's component and device inventory to determine whether or not it can fulfill the request. If the ABS is unable to fulfill the request at this time, i.e., it cannot produce the requested beverage, it will state why, provide a list of what is required so that it can fulfill the request, and offer other options.

If the ABS is able to create the requested beverage at this time, the computer/controller 700 will calculate all movements and processes required, such as which components need to be dispensed and how much, and then proceed to move drink shuttle 510 into the appropriate position on x-y stage 500.

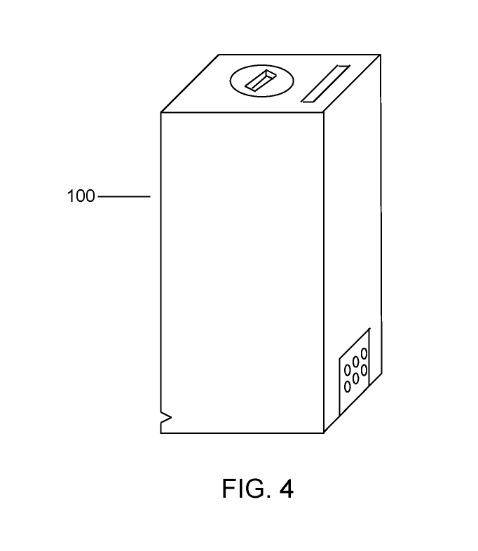

When in the correct position, the appropriate component cartridge 100, shown in more detail in FIG. 4, will eject the required quantity of the fluid or powder it contains into beverage container 900. If necessary, the carrier 200 holding said component cartridge 100 may be moved into position under the command of computer/controller 700 using an electrically-driven double-stack looping magazine arrangement which minimizes the space requirements for the carriers within the ABS's enclosure. The drink shuttle 510 is moved as needed to enable beverage container 900 to receive the required components and any other treatments, such as mixing by mixer 410, aeration by gas injection 411, chilling by cold finger 412, heating by infrared lamp 413, or by the addition of ice from ice chipper 422, ice shaver 423, or ice cube maker 421.

If the beverage requires one or more components that are in solution, but the solvent or solvents are not a component of said beverage, or a lesser quantity of said solvent is required, then these component solutions would be dispensed into the beverage container 900 first. The beverage container 900 may then be positioned beneath infrared lamp 413 which is then utilized to heat up and evaporate the solvent or solvents. The resulting fumes are collected and filtered by fume collector and filtration unit. The major fluid component of the beverage is then added to the solventless residue and ultrasound sonicator tip 414 is used to break up the residue and suspend it in the liquid (in which it may, or may not, be soluble).

Optional characterizing instrumentation may be incorporated, such as a pH analyzer, fiber-optic spectrophotometer probe, and viscometer, so that the physical attributes of the product may be monitored and adjustments may be made.

When the beverage is ready to be served, shuttle 510 will return to a point convenient for removal from the ABS. After removal of beverage container 900 from the ABS, an optional cleaning system incorporated into the ABS may proceed to clean the parts requiring cleansing in order to minimize cross-contamination of the next product serving.

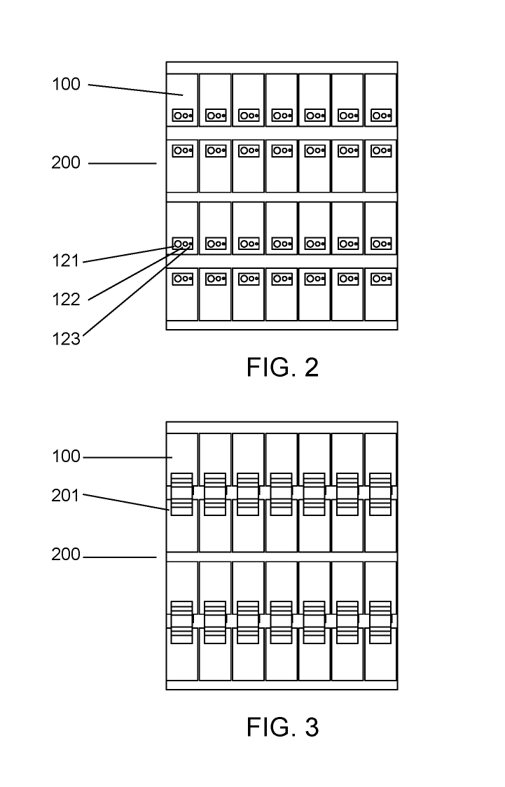

It should be noted that it is beneficial to have component cartridges 100 capable of holding different quantities, or, if in solution form, different concentrations, of certain components. For example, ethanol is far more likely to be used in greater quantities than isoamyl acetate (banana oil) or propiophenone (cherry/pistachio flavor). Thus, a dispensing system from other containers located either internally or externally and supplied via metering pumps 350 would be advantageous for components such as ethanol. In the ABS shown, carrier 200 holds standard-sized cartridges as shown in FIGS. 2 and 3. As can be seen in FIG. 2, these cartridges 100 have three emitter nozzles 121, 122, and 123 corresponding to differently sized emission volumes to accommodate a wide range of component quantity requirements in a reasonable time period. The cartridges 100 can be easily removed for refilling or replacement and are secured in carrier 200 via latches 201 as seen in FIG. 3. Larger containers such as the ethanol storage bottle 310 are located below the x-y stage 500 in FIG. 1.

While all components could be delivered from cartridges, it is often more convenient to have water delivered from a connected water line. However, since tap water is rarely of sufficient purity for the purposes of the ABS, a filtration and purification system should be incorporated, preferably one utilizing reverse-osmosis.

Gases, such as carbon dioxide and nitrous oxide are also more conveniently supplied from pressurized cylinders. However, air is more conveniently supplied via in situ compression of air taken from the atmosphere immediately outside of the ABS. For the most reproducible results, it is best if said air is filtered at some point between intake and injection into the beverage.

While beverage synthesizers are one class of devices embodied under the present invention, fragrance synthesizers are another class so embodied. Fragrance synthesizer embodied under the present invention would, in general, require less auxiliary equipment than most beverage synthesizers embodied under the present invention. For example, a fragrance synthesizer most likely would not require a steam injector and frother. Nor is a fragrance synthesizer likely to require an ice cube maker, ice shaver, ice chipper, cold finger, nor carbonators. Most embodiments of fragrance synthesizers would only require a means of positioning the receiving container relative to the component cartridges and any mixing implements; an array, or arrays, of standard component cartridges, one or more large ethanol containers; a water dispensing system; one or more mixing implements; a self-cleaning system; if more than one array of cartridges is used, a system for presenting the different arrays to the receiving container; a computer/controller; other necessary associated systems for these components; and a suitable housing.

These devices may be readily manufactured by artisans skilled within the field appropriate to the component or system. The technologies involved in the various systems are well established and understood. The analytical techniques and software required for the establishment of the required component profile database are well known by skilled artisans in the fields of analytical chemistry and computer programming, respectively.

I claim:

1) A device for creating a multiplicity of fluid compositions in discrete quantities comprising:
(a) a multiplicity of cartridges;
(b) wherein some of said cartridges contains a fluid reservoir;
(c) wherein said fluid reservoir is either a single chemical compound, a solution of a single chemical compound dissolved in an appropriate solvent, or a composition of several compounds;
(d) wherein a means exists to control when and how much of a cartridge's contents are dispensed into a receiving container;
(e) wherein a means exists to cause either said receiving container to move relative to the cartridges or the cartridges to move relative to the receiving container;
(f) wherein other means to add components to said composition may, or may not, exist;
(g) wherein means to agitate, heat, chill, aerate, carbonate, inject steam into, froth, mix, stir, shake, or otherwise alter, modify, or manipulate said composition may, or may not exist;
(h) wherein a computerized database, either contained in said device, or accessed remotely, holds data on one or more possible compositions that may be produced by the device; and
(i) wherein a computer, utilizing said database, controls the production of said composition in response to a user request.

2) The device of claim 1 wherein:
(a) a means of determining the temperature, color, pH, viscosity, or other properties of said composition is incorporated; and
(b) a means of adjusting at least one of said properties may, or may not, be incorporated.

3) The device of claim 1 when used to prepare beverages.

4) The device of claim 1 when used to prepare fragrances.

5) The device of claim 1 wherein the multiplicity of cartridges are arranged in one or more arrays.

6) The device of claim 5 when used to prepare beverages.

7) The device of claim 5 when used to prepare fragrances.

8) The device of claim 5 wherein said means of causing the motion of said fluid container relative to said array is comprised of a shuttle which holds said fluid container and wherein said shuttle is movable along two or more axes.

9) The device of claim 8 when used to prepare beverages.

10) The device of claim 8 when used to prepare fragrances.

11) The device of claim 5 wherein said arrays are arranged such that said arrays are part of a continuous loop conveyor system which presents one or more arrays at a time to said fluid container.

12) The device of claim 11 when used to prepare beverages.

13) The device of claim 11 when used to prepare fragrances.
